(19) United States
(12) Patent Application Publication
(10) Pub. No.: US 2006/0216202 A1
(43) Pub. Date: Sep. 28, 2006

(54) Method and apparatus for determining the activity and aging behavior of a catalyst

(75) Inventors: Jurgen Gieshoff, Gelnhausen (DE); Hartmut Finkbeiner, Baiersbronn (DE); Egbert Lox, Hochwaldhausen (DE); Thomas Kreuzer, Karben (DE)

Correspondence Address: KALOW & SPRINGUT LLP, 488 MADISON AVENUE, 19TH FLOOR, NEW YORK, NY, 10022, US

(73) Assignee: Umicore AG &CO. KG, 63457 Hanau -Wolfgang (DE)

(21) Appl. No.: 10/559,555

(22) PCT Filed: Jun. 3, 2004
(86) PCT No.: PCT/EP04/06005

§ 371 Date: Apr. 3, 2006

(30) Foreign Application Priority Data
Jun. 4, 2003 (DE) 10325292.4

(51) Int. Cl. G01N 31/10

(52) U.S. Cl. 422/80; 436/37

(57) ABSTRACT

The invention relates to a method of determining activity and aging behavior of a catalyst. For this purpose, two independent substreams of combustion offgases are produced and mixed before coming into contact with the catalyst. The first substream of combustion offgases is preferably produced by burning a motor fuel and forms the major part of the combustion offgases. The second substream of combustion offgases is produced by means of a gas burner whose air ratio can be adjusted within a wide range. Mixing of this second substream of combustion offgases into the first substream enables the composition of the total stream to be set in a defined manner.

The invention relates to a method and an apparatus for determining the catalytic activity and the aging behavior of a catalyst for purifying the exhaust gases of internal combustion engines.

Activity studies on exhaust gas purification catalysts for internal combustion engines are usually carried out in model gas units or directly on the engine.

Model gas units comprise a reactor containing the catalyst to be examined, a gas mixing device and an analysis unit. The gas mixing device allows a limited number of different gases, for example oxygen, nitrogen, carbon dioxide, carbon monoxide, nitrogen monoxide, gaseous hydrocarbons and water vapor, to be mixed to form a synthetic exhaust gas in order to test the conversion of various pollutants by the catalyst. However, a disadvantage is that the synthetic exhaust gas only unsatisfactorily reproduces the real exhaust gas from an internal combustion engine. For this reason, the model gas studies are not able to make any reliable predictions about the behavior of the catalyst on the engine and are therefore suitable only for assessing the influence of changes in the catalyst formulation during the development phase.

Adherence to particular limits for pollutants emitted by an engine required by exhaust gas legislation can only be achieved by matching the catalyst formulation to the particular engine type under consideration. For this purpose, engine test benches are used. An engine test bench comprises an engine of the type under consideration together with all its supply equipment, control elements and the exhaust gas unit in which the catalyst to be tested is installed.

Testing on the engine is naturally carried out with real exhaust gas compositions, but has only limited suitability for rapid testing of various catalyst formulations during the development of new catalysts. Furthermore, engine test benches are expensive to acquire and also to operate and maintain. A further disadvantage of an engine test bench is the unsatisfactory reproducibility of the operating conditions. In addition, the exhaust gas composition is a function of the power level at which the engine is being operated and is thus dependent on the further test parameters.

To determine the influence of the motor oil on the aging of a catalyst, it has been proposed that the exhaust gas from the engine be simulated with the aid of a burner (research report 08-9217 of the Southwest Research Institute, San Antonio, Tex.). In addition, burners are used to study the thermal load which can be imposed on complete exhaust gas units.

It is an object of the present invention to provide a method and an apparatus for determining catalyst activity which allow an exhaust gas from an engine to be simulated inexpensively, very realistically and reproducibly for the purpose of testing a catalyst.

According to the invention, this object is achieved by producing a stream of hot combustion offgases having a defined pollutant composition by mixing a first substream of hot combustion offgases with a second substream of hot combustion offgases. The total stream of combustion offgases is then passed over the catalyst to be tested and the pollutant conversions effected by the catalyst are determined.

According to the invention, two substreams of combustion offgases are produced by two independent combustion processes and are mixed before coming into contact with the catalyst. The first substream of the combustion offgases provides the major part of the mass flow of the mixed combustion offgases. Its heating power is usually above 10 kW. Its composition, in particular its pollutant composition, can be influenced in a viable manner only within narrow limits. To be able to set a defined pollutant composition, the first substream of combustion offgases is mixed with a second, smaller substream of combustion offgases which come from a readily adjustable or regulatable combustion process.

The mass flow of the first substream of hot combustion offgases is preferably from 60 to 95%, in particular from 80 to 95%, of the total mass flow of the two substreams and is preferably produced by burning a motor fuel in a first stream of combustion air. The motor fuel used should correspond to the future use of the catalyst. For this reason, a diesel fuel is used for testing a diesel catalyst and a four-stroke fuel is used for testing catalysts for four-stroke engines.

The combustion process for forming the first substream of combustion offgases should be operated at a very stable operating point. Its air ratio lambda is preferably chosen so as to be greater than 1, i.e. it is operated under lean conditions to avoid soot formation.

The air ratio lambda is the air/fuel ratio standardized to stoichiometric conditions. The air/fuel ratio for stoichiometric combustion of conventional motor fuels is about 14.6, i.e. 14.6 kilograms of air are required for complete combustion of one kilogram of fuel. The air ratio lambda at this point is equal to 1. Lambda values below 1 are referred to as rich and lambda values above 1 are referred to as lean.

The air ratio to be set in the first combustion process depends essentially on the type of catalyst to be examined. To test a three-way catalyst, the air ratio has to be close to one. To examine the activity of diesel catalysts, air ratios of 1.5 and greater are required. In this field of application in particular, the provision of sufficiently high pollutant concentrations by means of a single combustion process is virtually impossible.

The second substream of combustion offgases is preferably produced by burning gaseous hydrocarbons in a second stream of combustion air. Such a combustion process can generally be regulated more easily than the combustion of liquid fuels. This property is important for the defined setting of the pollutant composition of the mixed offgas stream. Thus, such a combustion process can also be operated in a stable fashion in the rich range. The preferred regulation range for the air ratio in this combustion process is from 0.5 to 3. In this way, the pollutant components formed (carbon monoxide CO, hydrocarbons HC and, from these, hydrogen H₂) can be obtained in appropriate concentrations. Even small deviations from the stoichiometric point result in pollutant concentrations in the percentage range. An important task of the second combustion process is to produce sufficient amounts of carbon monoxide as pollutant component in the mixed offgas.

To influence the pollutant composition of the mixed combustion offgases further, particular additives can be added to the combustion air and to the fuel for the respective combustion process. These additives can, for example, have been mixed in the desired concentrations into the respective fuel or can be added to the fuel shortly before it enters the combustion process.

To increase the nitrogen oxide concentration in the first and/or second substream of the combustion offgases, it can be advantageous to add ammonia or aqueous ammonia to the first and/or second stream of combustion air. To test the influence of poisoning elements such as lead, zinc, phosphorus, calcium and sulfur on the catalytic activity and aging stability of the catalyst, these elements can be added in the form of appropriate precursor compounds, for example in the form of motor oil or an additive package (additives which are mixed into the motor oil) to the fuel for the first combustion process.

In the case of extremely rich operating conditions (lambda less than 0.8) in the second combustion process, water can be added to the second stream of combustion air in order to suppress soot formation. To increase the proportion of unburnt hydrocarbons in the combustion offgas, hydrocarbons which are difficult to oxidize can be mixed into the fuel or the offgas of the second combustion process.

The first combustion process gives a relatively high offgas temperature of above 700° C. To prevent the oxidizable constituents of the second substream of combustion offgases being burnt when the two combustion offgases are mixed, the temperature of the first substream of combustion offgases can be reduced, for example, to values below 800 down to 200° C. before the two offgas streams are mixed with one another. Cooling has to ensure that the temperature of the gas mixture produced is not above the ignition temperature.

The offgas temperature is an important parameter in the testing of the catalytic activity of the catalyst. It is therefore advantageous to match the temperature of the offgases after mixing to the test requirements and to set the offgas temperature to a defined value before contact with the catalyst. This can mean either further cooling of the offgases or even a renewed increase in the offgas temperature.

Furthermore, the process allows hydrocarbons, oil additives or further gaseous or vaporizable components to be added to the mixed offgases before contact with the catalyst. Thus, ammonia can be added to the mixed offgases in order to examine the activity of SCR catalysts.

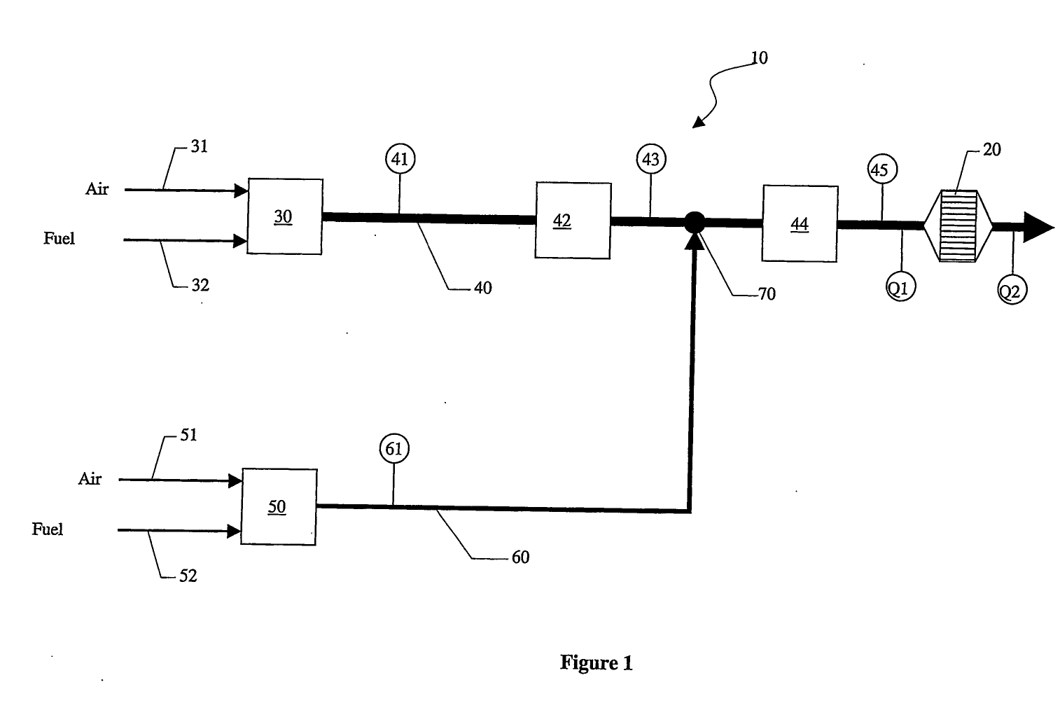

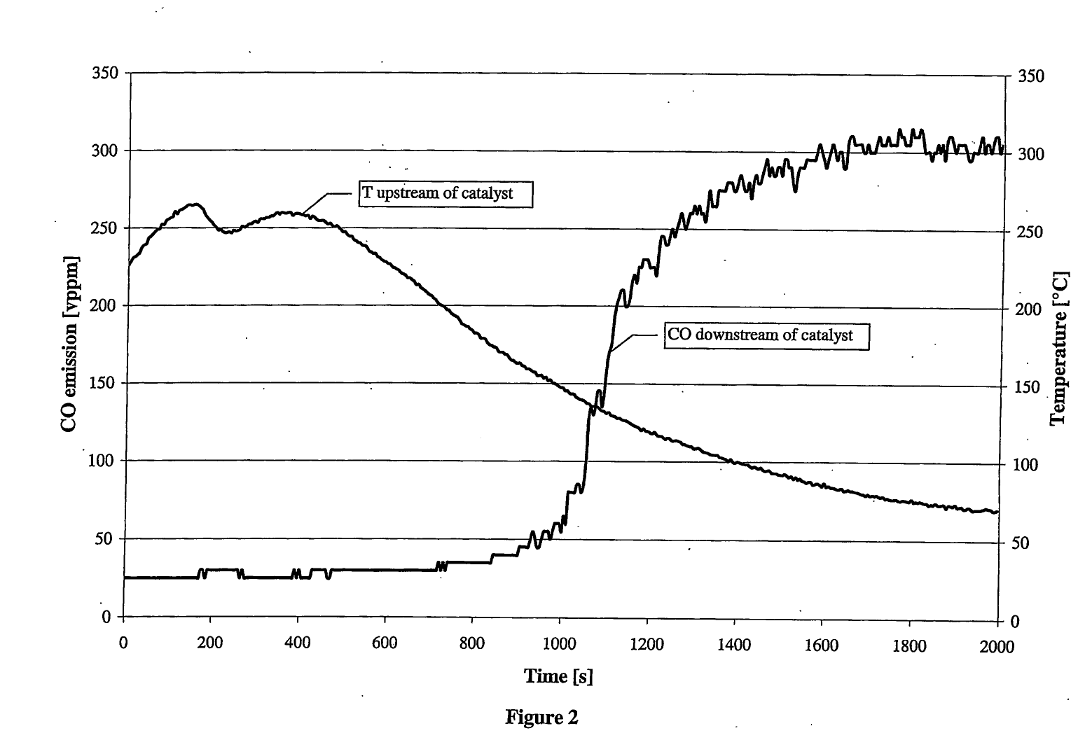

The invention is explained in more detail below with the aid of FIGS. 1 and 2 and a working example. In the figures:

FIG. 1: shows a possible outline of an apparatus for carrying out the proposed process

FIG. 2: shows the measured emission of carbon monoxide downstream of an oxidation catalyst for various offgas temperatures

FIG. 1 shows the possible outline of an apparatus (10) for carrying out the process of the invention. The apparatus comprises a first burner (30) for producing the first substream of combustion offgases. The burner has an offgas line (40) in which the catalyst (20) to be tested is installed. According to the invention, the apparatus comprises a second burner (50) for producing the second substream of combustion offgases. The second burner has an offgas line (60) which opens into the offgas line (40) of the first burner (30) at the point (70) upstream of the catalyst (20).

The first burner (30) is preferably configured as a liquid fuel burner which is supplied via the feed line (32) with a motor fuel as fuel and via the feed line (31) with a first stream of combustion air. The second burner (50) is preferably configured as a gas burner and is supplied via the feed line (52) with a gaseous fuel and via the feed line (51) with a second stream of combustion air.

To set the air ratios of the combustion offgases, a lambda probe (41) and (61) is installed in the two offgas lines (40) and (60), respectively, and these probes are used to regulate the air ratios via appropriate regulation circuits.

Upstream of the point at which the offgas line of the second burner joins the offgas line of the first burner, a heat exchanger (42) is installed in the offgas line of the first burner. This heat exchanger reduces the generally very high offgas temperature of the first burner to a value below 800° C. so as to reduce the influence of the first burner on the offgas composition of the second burner. To regulate this cooling step, a temperature sensor (43) is provided downstream of the heat exchanger.

Matching of the offgas temperature to the test requirements of the catalyst is effected by means of a further heat exchanger (44) which is located in the offgas line just before the catalyst (20). The temperature sensor (45) measures the offgas temperature before the offgas enters the catalyst. To analyze the pollutant conversions achieved by the catalyst, appropriate pollutant sensors (Q1) and (Q2) or analytical facilities are located upstream and downstream of the catalyst.

The process proposed above can be carried out using the apparatus shown by way of example in FIG. 1. The first burner serves to produce an offgas stream having characteristics similar to that produced by an engine in terms of the significant offgas (exhaust gas) components. It is advantageous for this burner to be operated using fuels typical of engines. However it is difficult to set pollutant concentrations in a targeted manner by means of this burner. In addition, the pollutant concentrations, in particular of CO and HC, are not within the range typical of engines because of the high combustion temperatures in this burner.

The second burner is of significantly lower power. The task of this burner is to produce CO and HC under “rich” offgas conditions. This can be achieved very simply by means of a gas burner (liquefied petroleum gas, natural gas and similar carbon-derived fuel gases). Such a gas burner can be operated stably at various air ratios.

The composition of the gas mixture downstream of the junction (70) can be set very stably within wide ranges on the basis of the different volume flows and gas concentrations.

Due to its flexibility, the process proposed offers a test range in terms of the pollutant composition, the mass flow of offgas and the temperature which can be achieved only with great difficulty on an engine. Typical applications of the process described and the apparatus are catalyst studies during the development phase and the setting-up of a catalyst mapping for catalyst modeling and control system programming.

The use according to the invention of two burners makes it possible to simulate an engine exhaust gas with high reproducibility.

### EXAMPLE

The activity of a diesel oxidation catalyst in respect of the oxidation of carbon monoxide was examined as a function of the temperature of the offgas using the process of the invention.

The catalyst comprised a cordierite honeycomb carrier having a cell density of 62 cm⁻² (400 cpsi) and a wall thickness of the flow channels of 0.2 mm (8 mil) which had been coated with a platinum-containing coating having a platinum loading of 3.2 g per liter (90 g/ft³) of honeycomb. The catalyst was tested in the fresh state.

For this purpose, the first burner was operated in a steady state at a heating power of 30 kW and an air ratio of 1.5. The mass flow of air was 56.5 kg/h. As fuel, use was made of diesel fuel. The second burner was operated using liquefied petroleum gas. Its heating power was 3 kW, i.e. only 10% of the heating power of the first burner. It produced an offgas having a CO content of 300 vppm (measured using an NDIR analyzer).

The temperature of the mixed offgas upstream of the heat exchanger (44) was 364° C. during the entire duration of the measurements. Before the offgas entered the catalyst, it was cooled from 250° C. to 70° C. at a rate of about 6° C./min by means of the heat exchanger (44). After leaving the catalyst, the concentration of carbon monoxide present in the offgas was measured. The space velocity over the catalyst was about 61 000 h⁻¹ during the measurements.

These space velocities are of an order of magnitude comparable to a standard light-off test as is used for determining the catalyst activity on typical engine test benches. However, there is the additional in-principle advantage of defined setting of the pollutant gas concentrations independently of the temperature, while in the case of engine tests the temperature is generally set via a load change. This load change also results in emission changes.

The results of these measurements are shown in FIG. 2.

1. A method of determining activity and aging behavior of a catalyst by producing a first substream and a second substream of combustion offgases by two independent combustion processes and a stream of hot combustion offgases having a defined pollutant composition by mixing the first substream of hot combustion offgases with the second substream of hot combustion offgases, passing the combustion offgases over the catalyst to be tested and determining the pollutant conversions effected by the catalyst.

2. The method as claimed in claim 1, wherein the first substream of hot combustion offgases makes up from 60 to 95% of the total mass flow of the two substreams.

3. The method as claimed in claim 2, wherein the first substream of hot combustion offgases is produced by burning a motor fuel in a first stream of combustion air and the second substream of hot combustion offgases is produced by burning gaseous hydrocarbons in a second stream of combustion air.

4. The method as claimed in claim 3, wherein the first substream of hot combustion offgases has an air ratio lambda of greater than 1.

5. The method as claimed in claim 4, wherein ammonia or aqueous ammonia is introduced into the first and/or second stream of combustion air in order to increase the nitrogen oxide concentration in the combustion offgases.

6. The method as claimed in claim 4, wherein poisoning elements in the form of precursor compounds are added to the motor fuel.

7. The method as claimed in claim 3, wherein the air ratio lambda of the second substream of combustion offgases is set to a value in the range from 0.5 to 3.

8. The method as claimed in claim 7, wherein water is introduced into the second stream of combustion air in order to avoid soot formation in the case of extremely rich operating conditions.

9. The method as claimed in claim 7, wherein hydrocarbons which are difficult to oxidize are added to the gaseous hydrocarbons.

10. The method as claimed in claim 3, wherein the temperature of the first substream of combustion offgases is reduced to a value in the range from 800 to 200° C. before it is mixed with the second substream of combustion offgases.

11. The method as claimed in claim 10, wherein hydrocarbons, oil additives or further gaseous or vaporizable components are added to the mixed combustion offgases before they are brought into contact with the catalyst.

12. The method as claimed in claim 11, wherein the temperature of the mixed combustion offgases is set to a defined value before contact with the catalyst.

13. An apparatus (10) for determining the activity and the aging behavior of a catalyst (20), which comprises a first burner (30) having an offgas line (40) in which the catalyst is located, wherein the apparatus further comprises a second burner (50) having an offgas line (60) which opens into the offgas line (40) of the first burner (30) upstream of the catalyst (20).

14. An apparatus as claimed in claim 13, wherein the first burner (30) is a liquid fuel burner which is supplied via the feed line (32) with a motor fuel as fuel and via the feed line (31) with a first stream of combustion air.

15. An apparatus as claimed in claim 14, wherein the second burner (50) is a gas burner which is supplied via the feed line (52) with a gaseous fuel and via the feed line (51) with a second stream of combustion air.

16. An apparatus as claimed in claim 15, wherein both offgas lines contain lambda probes (41) and (61).

17. An apparatus as claimed in claim 16, wherein a first heat exchanger (42) and a first temperature sensor (43) are provided in the offgas line of the first burner upstream of the junction with the offgas line of the second burner.

18. An apparatus as claimed in claim 17, wherein a second heat exchanger (44) and a second temperature sensor (45) are located in the offgas line of the first burner downstream of the junction with the offgas line of the second burner.

19. An apparatus for determining activity and aging behavior of a catalyst, in particular for implementing a method as claimed in claim 1, comprising:
a facility for producing a stream of hot combustion offgases having a defined pollutant composition, where the production facility has a first facility for providing a first substream of hot combustion offgases, a second facility being independent from the first facility for providing a second substream of hot combustion offgases and a facility for mixing the first substream and the second substream, a facility for passing the combustion offgases over the catalyst to be tested and a facility for determining the pollutant conversion effected by the catalyst.
